(19) United States
(12) Patent Application Publication
(10) Pub. No.: US 2007/0159846 A1
(43) Pub. Date: Jul. 12, 2007

(54) SURFACE EMITTING DEVICE

(75) Inventors: Yoshinori Nishiyama, Miyagi-ken (JP); Ayumu Kobayashi, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/617,676

(22) Filed: Dec. 28, 2006

(30) Foreign Application Priority Data
Jan. 11, 2006 (JP) 2006-003969
Jan. 11, 2006 (JP) 2006-003972

(51) Int. Cl. F21V 7/04

(52) U.S. Cl. 362/602

(57) ABSTRACT

A surface emitting device is provided. The surface emitting device includes a light guide and a light source. The light guide includes a circular portion that curves light, and a light entrance portion that protrudes from the outer peripheral surface of the circular portion. The light source emits light toward the light entrance portion. The light source is disposed in a hollow formed in the center of the light entrance portion. The outer wall surface of the light entrance portion has a reflecting portion. The reflecting portion includes first and second reflecting surfaces that adjoin at an obtuse angle. Light of the light source heading from the inner wall surface to the outer wall surface of the light entrance portion is reflected by the reflecting portion so as to head into the circular portion.

This patent document claims the benefit of Japanese Patent Application No. 2006-003969 filed on Jan. 11, 2006 and Japanese Patent Application No. 2006-003972 filed on Jan. 11, 2006, which are both hereby incorporated by reference.

### BACKGROUND

1. Field

The present embodiments relate to a surface emitting device.

2. Related Art

Surface emitting devices are generally known in the related art. For example, Japanese Unexamined Patent Application Publication No. 2004-227855 discloses a rotary operating electric component used in car-mounted air conditioning systems and audio systems. The rotary operating electric component includes a rotary knob that is operated by a car occupant and a circular thin plate that is disposed around the knob. The plate has display portions arranged along the circumferential direction. In order to view the rotational operational position of the rotary knob even in the dark, a surface emitting device is widely used.

The surface emitting device includes a light source, such as a lamp, and a circular light guide that is disposed behind the plate and that guides the light of the light source to the display areas of the plate.

FIGS. 7 to 9 illustrate a known surface emitting device disclosed in the Japanese Unexamined Patent Application Publication No. 2004-227855. FIG. 7 is a sectional view of a rotary operating electric component to which the surface emitting device is applied. FIG. 8 is a plan view of the rotary operating electric component. FIG. 9 is a perspective view of a light guide provided in the surface emitting device.

The rotary operating electric component 1 shown in these figures includes a rotary knob 2, a rotary encoder (only the rotating shaft 6 thereof is shown), a thin circular plate 3, a holder 4, a circular light guide 5, a light source 7, and a circuit board 8. The rotary knob 2 is rotationally operated by a car occupant. The rotary encoder is rotationally driven in conjunction with the rotary knob 2. The plate 3 is disposed around the rotary knob 2. The inner periphery and the outer periphery of the back surface of the plate 3 are fixed to the holder 4 by adhesion. The holder 4 holds the circular light guide 5. The light source 7 is, for example, a lamp and is disposed adjacent to a light entrance portion 5c of the circular light guide 5. The rotary encoder and the light source 7 are mounted on the circuit board 8. The plate 3 has display portions 3a arranged along the circumferential direction. The display portions 3a are areas to be illuminated. The circular light guide 5 is opposite the back surface of the display portions 3a of the plate 3.

The circular light guide 5 is molded from a highly light-transmissive material, such as acrylic resin. The circular light guide 5 includes a small-diameter inner ring 5a, a large-diameter outer ring 5b, and a light entrance portion 5c. The inner and outer rings 5a and 5b are joined to each other. The light entrance portion 5c lies on an extension of the joint between the rings and protrudes from the outer peripheral surface of the outer ring 5b. In plan view, the light entrance portion 5c has a shape of a triangle whose base is the outer peripheral surface of the outer ring 5b.

The light source 7 is disposed opposite a cutout depression in the underside of the apex of the light entrance portion 5c (see FIG. 7). Light of the light source 7 incident on the light entrance portion 5c is guided into the rings 5a and 5b and emitted upward by the circular light guide 5. The illuminating light emitted from the upper surface of the inner ring 5a illuminates a position mark 2a of the rotary knob 2. The illuminating light emitted from the upper surface of the outer ring 5b illuminates the display portions 3a of the plate 3.

Japanese Unexamined Patent Application Publication No. 2004-288585 discloses a light guide having no inner ring 5a. The light guide has only an outer ring 5b referred to as circular portion. A light entrance portion 5c that is triangular in plan view protrudes from the outer peripheral surface of the circular portion.

In the rotary knob 2, only the place where the position mark 2a lies is the area to be illuminated. The rotary knob 2 has a flange 2b for preventing leakage of illuminating light. The plate 3 is formed of a light-transmissive resin. The upper surface of the plate 3 is provided with light blocking coating except the display portions 3a. A color toning sheet is attached throughout the lower surface of the plate 3. The display portions 3a are illuminated by the circular light guide 5 with light in a desired color according to the toning sheet.

The display portions 3a are areas to be illuminated where figures and/or characters are arranged along the circumferential direction. The figures and characters provide an indication of the rotational position of the rotary knob 2. By viewing which display portion 3a is indicated by the position mark 2a, a car occupant can view the rotational operational position of the rotary knob 2.

The holder 4 is molded from a resin and serves as an upper case to be integrated with a lower case (not shown). The holder 4 has a small-diameter circular portion 4a and a large-diameter circular portion 4b. The plate 3 is fixed to the upper end faces of the circular portions 4a and 4b by adhesion. The circuit board 8 is attached to the lower case. The rotary operating electric component 1 is electrically connected to an external circuit via a connector (not shown) provided in the circuit board 8 or the lower case.

The rotary operating electric component 1 configured as above is fitted in a circular opening 11 formed in a front panel 10 in a vehicle cabin, with the display portions 3a of the plate 3 and the rotary knob 2 exposed, and is set so that the rotary knob 2 protrudes from the opening 11. When a car-occupant rotationally operates the rotary knob 2, the rotational operational position can be known by viewing the position of the position mark 2a relative to the display portions 3a. Even in the dark, for example, at night, the position mark 2a and the display portions 3a can be easily viewed due to illuminating light from behind, and therefore the car-occupant can rotationally operate the rotary knob 2 without trouble.

In the above-described known surface emitting device, the light source 7 is disposed opposite the apex of the triangular light entrance portion 5c protruding from the outer peripheral surface of the circular light guide 5. Light of the light source 7 is incident on the apex of the light entrance portion 5c and is guided into the rings 5a and 5b, which are located on the base side of the triangular light entrance portion 5c.

If the protruding amount of the light entrance portion 5c is reduced in order to reduce the size of the surface emitting device, the triangular shape of the light entrance portion 5c becomes flat, and light of the light source 7 cannot be efficiently guided into the rings 5a and 5b. For this reason, the protruding length required for the light entrance portion 5c (the length in the radial direction of the circular light guide 5) needs to be large. Consequently, the light entrance portion 5c protrudes by a large amount from the outer peripheral surface of the outer ring 5b. In the case where such a surface emitting device is fitted behind a panel of systems such as car-mounted air conditioners, the size of the systems needs to be large and the component layout is difficult. Of the light rays emitted in all directions from the light source 7, only the light rays emitted forward are incident on the light entrance portion 5c of the circular light guide 5. Therefore, only a small portion of light rays emitted from the light source 7 can be utilized for illuminating the areas to be illuminated. This causes insufficient illumination or increased power consumption of the light source 7.

The light entrance portion 5c protrudes from the outer peripheral surface of the outer ring 5b of the circular light guide 5. The light source 7 is disposed opposite the apex of the triangular shape of the light entrance portion 5c. Light of the light source 7 is incident on the apex of the light entrance portion 5c and is guided into the rings 5a and 5b, which are located on the base side of the triangle. Therefore, light heading from the light source 7 to the center of the rings 5a and 5b passes through the inner peripheral surface of the inner ring 5a.

In the surface emitting device disclosed in Japanese Unexamined Patent Application Publication No. 2004-288585, a light source is disposed opposite the apex of the triangular shape of the light entrance portion protruding from the outer peripheral surface of the circular portion. Light of the light source is incident on the apex of the light entrance portion and is guided into the circular portion. Therefore, light heading from the light source to the center of the circular portion passes through the inner peripheral surface of the circular portion. Therefore, in both cases, the light passes through, i.e., leaks from the inner peripheral surface of the circular portion (the inner ring 5a). In this case, the amount of illuminating light for the area to be illuminated decreases. This causes insufficient illumination of the area to be illuminated or increased power consumption of the light source.

### SUMMARY

The present embodiments may obviate one or more of the limitations or drawbacks of the related art. For example, in one embodiment, a small surface emitting device has a light source that includes efficient illumination.

In one embodiment, a surface emitting device includes a light guide and a light source. The light guide includes a circular portion and a light entrance portion protruding from the outer peripheral surface of the circular portion. The light source emits light toward the light entrance portion. The light source is disposed in a hollow formed substantially in the center of the light entrance portion. The outer wall surface of the light entrance portion has a reflecting portion bulging outward, and light heading from the light source to the outer wall surface of the light entrance portion is reflected by the reflecting portion so as to head into the circular portion.

In one embodiment, the light source is disposed in the hollow formed substantially in the center of the light entrance portion. Therefore, the protruding amount of the light entrance portion may be reduced, and the size of the light guide in the radial direction may be reduced. In addition, light emitted laterally from the light source and heading to the outer wall surface of the light entrance portion is reflected by the reflecting portion so as to head into the circular portion. Therefore, the utilization efficiency of the light source may be improved.

In one embodiment, the reflecting portion includes a first reflecting surface nearer to the light source and a second reflecting surface farther from the light source. The first reflecting surface and the second reflecting surface adjoin at an obtuse angle. The entire shape of the circular portion including the light entrance portion may be simplified.

In one embodiment, the inner wall surface of the light entrance portion defining the hollow has an outer collective lens that is convex and formed between the light source and the first reflecting surface. Light from the light source may be refracted by the outer collective lens so as to head to the first reflecting surface. A large part of the light incident on the inner wall surface of the light entrance portion from the light source may be utilized as illuminating light.

In one embodiment, the inner wall surface of the light entrance portion have an inner collective lens that is convex and adjoins the outer collective lens. Light from the light source may be refracted by the inner collective lens so as to head into the circular portion. A larger part of the light incident on the inner wall surface of the light entrance portion from the light source may be utilized as illuminating light.

In one embodiment, a surface emitting device includes a light guide and a light source. The light guide includes a circular portion and a light entrance portion protruding from the outer peripheral surface of the circular portion. The light source emits light toward the light entrance portion. The circular portion includes an emitting surface and a reflecting surface facing each other. The inner peripheral surface of the circular portion has a groove whose both edges face each other in the circumferential direction and whose cross section converges outward so as to have a V shape. The light source is disposed on an extension of a line connecting the apex of the groove and the center of the circular portion.

In one embodiment, light emitted from the light source and heading to the center of the circular portion is reflected by the slant surfaces of the groove so as to head into the circular portion. Leakage light passing through the inner peripheral surface of the circular portion and heading to the center of the circular portion may be eliminated, and thereby the utilization efficiency of the light source may be improved.

In one embodiment, the end of the groove on the emitting surface side may be closed, and the closed end may have a slant surface that slants toward the emitting surface. Part of the light heading from the light source to the center of the circular portion is guided by the slant surface to the closed end of the groove. Despite the groove, the luminance of the emitting surface does not fall locally at the groove. The entire emitting surface including the place where the groove is formed can have a uniform luminance throughout the circumference.

Although the light source may be disposed opposite the apex of the light entrance portion that is triangular in plan view, it is preferable that the light entrance portion have a hollow formed substantially in the center thereof, and the light source be disposed in the hollow. The protruding amount of the light entrance portion can be reduced, and the size of the light guide in the radial direction can be reduced.

In one embodiment, the light source is disposed in the hollow formed substantially in the center of the light entrance portion protruding from the outer peripheral surface of the circular portion of the light guide. The protruding amount of the light entrance portion may be reduced, and the size of the light guide in the radial direction may be reduced. Light emitted laterally from the light source and heading to the outer wall surface of the light entrance portion is reflected by the reflecting portion so as to head into the circular portion. Light of the light source may be effectively utilized, and the illumination efficiency may be improved.

In one embodiment, the inner peripheral surface of the circular portion has a groove whose both edges face each other in the circumferential direction and whose cross section converges outward so as to have a V shape. The light source is disposed on an extension of a line connecting the apex of the groove and the center of the circular portion. Light emitted from the light source and heading to the center of the circular portion is reflected by the slant surfaces of the groove so as to head into the circular portion. Therefore, leakage light passing through the inner peripheral surface of the circular portion and heading to the center of the circular portion is eliminated, and thereby the utilization efficiency of the light source can be improved.

### BRIEF DESCRIPTION OF THE DRAWINGS

FIG. 1 is a perspective view of one embodiment of a light guide provided in a surface emitting device;

FIG. 2 is a perspective view showing one embodiment of the underside of the light guide;

FIG. 3 is a sectional view showing one embodiment of the surface emitting device in use;

FIG. 4 is a horizontal sectional view of one embodiment of a light entrance portion of the light guide;

FIG. 5 is a vertical sectional view of one embodiment of the light entrance portion of the light guide;

FIG. 6 two-dimensionally illustrates one embodiment of the paths of light rays emitted from a light source;

FIG. 7 is a sectional view of one embodiment of a rotary operating electric component to which a known surface emitting device is applied;

FIG. 8 is a plan view of the rotary operating electric component according to the related art; and

FIG. 9 is a perspective view of a light guide provided in the surface emitting device according to the related art.

### DETAILED DESCRIPTION

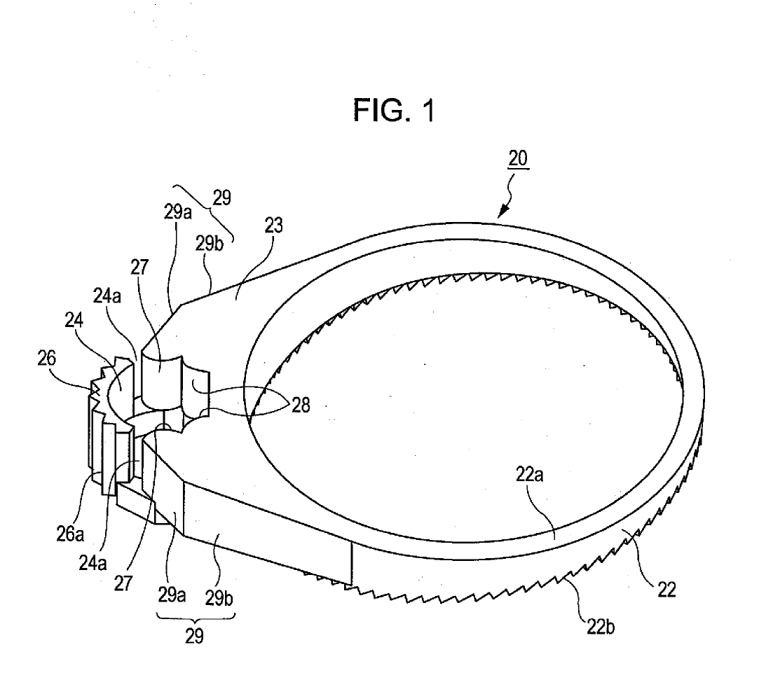

In one embodiment, as shown in FIG. 1, a surface emitting device includes a light guide 20 and a light source 21. The light guide 20 is molded from a highly light-transmissive material, for example, acrylic resin. The light source 21 emits light into the light guide 20. A lamp is used as the light source 21. The light guide 20 includes a circular portion 22 that curves light and a light entrance portion 23. The light entrance portion 23 is integral with the circular portion 22 and protrudes outward from the outer peripheral surface of the circular portion 22. The circular portion 22 becomes thinner away from the light entrance portion 23. The upper side of the circular portion 22 is a flat emitting surface 22a. The lower side of the circular portion 22 is a serrated reflecting surface 22b.

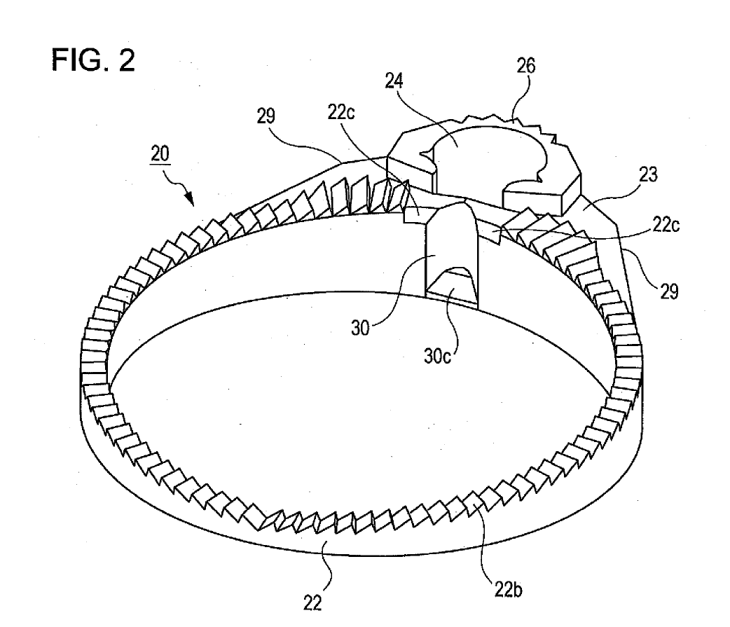

In one embodiment, as shown in FIG. 2, the serrated reflecting surface 22b has many teeth that extend in the radial direction and that adjoin along the circumferential direction. Light curving in the circular portion 22 is reflected by the serrated reflecting surface 22b and emits from the emitting surface 22a. The light entrance portion 23 has a hollow 24 provided in the center thereof.

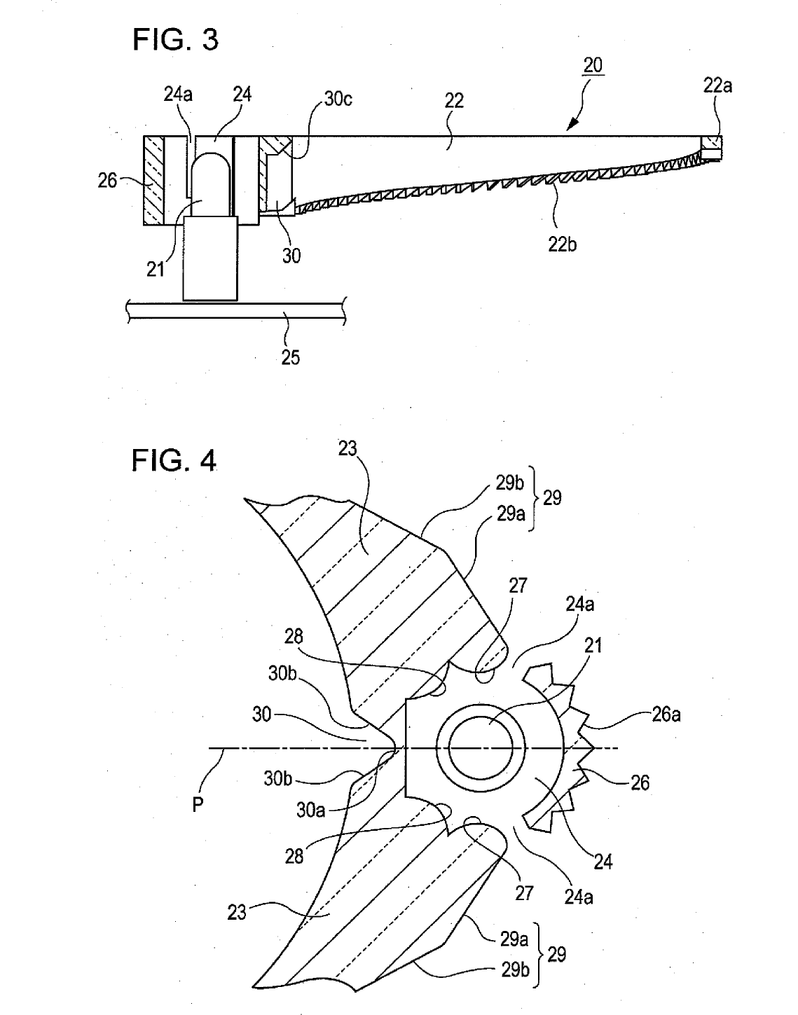

In one embodiment, as shown in FIG. 3, the light source 21 is mounted on a circuit board 25 and is disposed in the center of the hollow 24.

The light entrance portion 23 of the light guide 20 will be described in detail. The hollow 24 is a through hole in the thickness direction of the light entrance portion 23. The upper end of the hollow 24 is open, and the light source 21 is exposed. The inner wall surface of the light entrance portion 23 defining the hollow 24 is provided with a pair of slits 24a that extend from the open end to the middle in the thickness direction. The area on the opposite side of the slits 24a from the circular portion 22 is a retroreflecting portion 26. The outer wall surface of the retroreflecting portion 26 has a plurality of ridges 26a extending in the thickness direction. Of the light rays emitted in all directions from the light source 21, the light lays emitted backward are reflected by the ridges 26a so as to head to the circular portion 22. The slits 24a need not necessarily be provided. The retroreflecting portion 26 may adjoin the inner wall surface of the light entrance portion 23.

In one embodiment, of the inner wall surface of the light entrance portion 23, the area on the circular portion 22 side of the slits 24a has two (left and right) pairs of an outer collective lens 27 and an inner collective lens 28.

In one embodiment, as shown in FIG. 4, the left and right pairs of an outer collective lens 27 and an inner collective lens 28 are symmetrical with respect to a line P connecting the light source 21 disposed in the hollow 24 and the center of the circular portion 22. In each of the left and right halves of the light entrance portion 23, the outer collective lens 27 is nearer to the slit 24a than the inner collective lens 28, and the outer collective lenses 27 adjoins the inner collective lens 28. Each of the left and right outer wall surfaces of the light entrance portion 23 has a reflecting portion 29 that bulges outward. Each reflecting portion 29 includes a first reflecting surface 29a nearer to the light source 21 and a second reflecting surface 29h farther from the light source 21. The first reflecting surface 29a and the second reflecting surface 29b adjoin at an obtuse angle near 180 degrees.

In one embodiment, the left and right reflecting portions 29 are also symmetrical with respect to the line P. In each of the left and right halves of the light entrance portion 23, the first reflecting surface 29a extends from the slit 24a along the outer wall surface of the light entrance portion 23 and adjoins the second reflecting surface 29b, and the second reflecting surface 29b adjoins the outer peripheral surface of the circular portion 22.

In one embodiment, the outer collective lens 27 lies between the light source 21 and the first reflecting surface 29a. The outer collective lens 27 is designed to refract light incident thereon from the light source 21 toward the first reflecting surface 29a. The inner collective lens 28 lies between the light source 21 and the circular portion 22. The inner collective lens 28 is designed to refract light incident thereon from the light source 21 into the circular portion 22.

In one embodiment, as shown in FIG. 2, the inner peripheral surface of the circular portion 22 has a V-shaped groove 30. The apex of the V shape, i.e., the valley 30a of the groove 30 lies substantially on the line P (see FIG. 4). For example, the center of the circular portion 22, the valley 30a of the groove 30, and the light source 21 lie on the same line P. The slant surfaces 30b of the groove 30 facing each other cross the line P slant toward the inner peripheral surface of the circular portion 22. The groove 30 extends in the thickness direction of the circular portion 22, maintaining the V-shaped cross section. The end of the groove 30 on the emitting surface 22a side is closed. This closed end has a slant surface 30c. The slant surface 30c slants from the valley 30a of the groove 30 toward the emitting surface 22a.

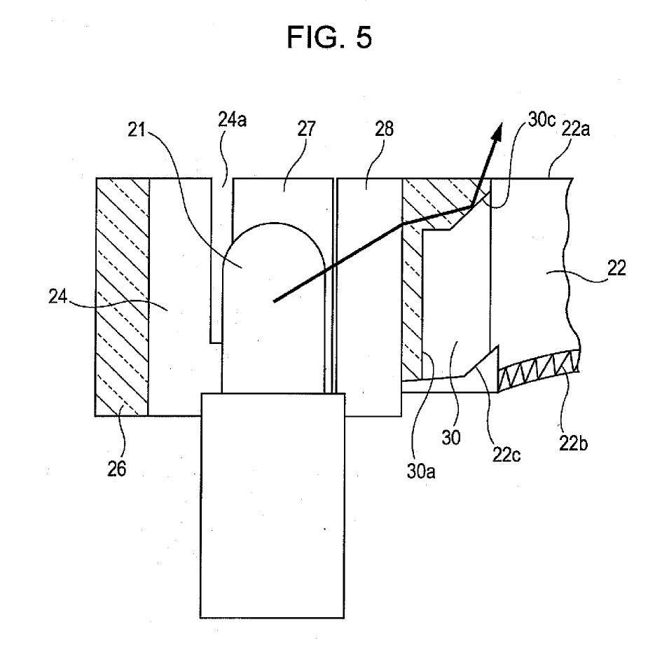

In one embodiment, as shown by an arrow in FIG. 5, light emitted from the light source 21 and heading to the upper closed end of the groove 30 is reflected by the slant surface 30c so as to emit from the emitting surface 22a. Alternatively, the end of the groove 30 on the serrated reflecting surface 22b is open. The underside of the circular portion 22 has a pair of slant surfaces 22c facing each other across the groove 30. The slant surfaces 22c also slant toward the emitting surface 22a. Light emitted from the light source 21 and heading to both sides of the lower end of the groove 30 is reflected by the slant surfaces 22c so as to emit from the emitting surface 22a. In this way, of light rays emitted in all directions from the light source 21, some of the light rays emitted forward and heading to the groove 30 are guided to the emitting surface 22a by the slant surfaces 30c and 22c. Therefore, despite the groove 30, the luminance of the emitting surface 22a does not fall locally at the groove 30. The emitting surface 22a can have a uniform luminance throughout the circumference.

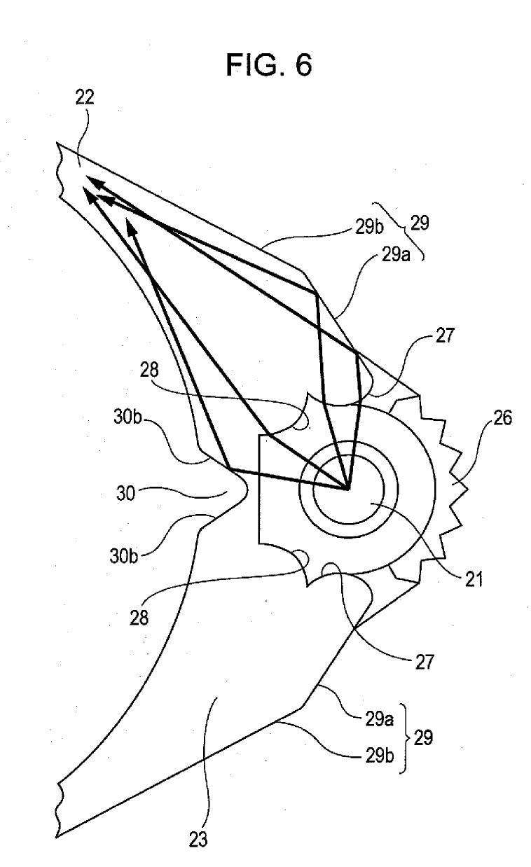

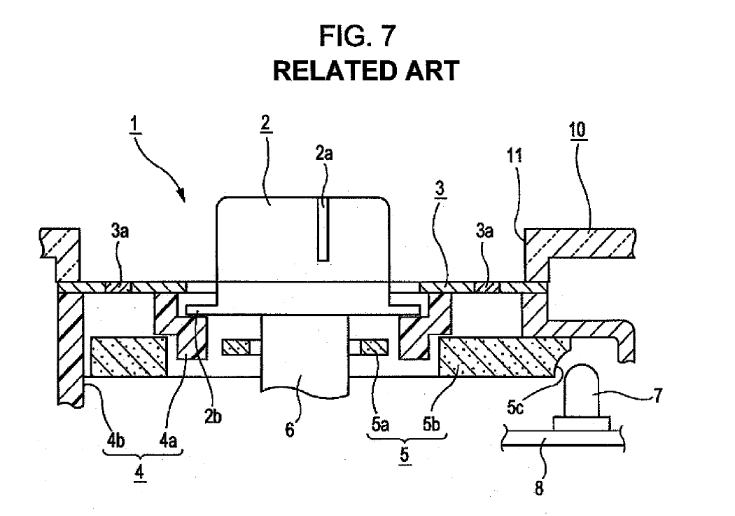

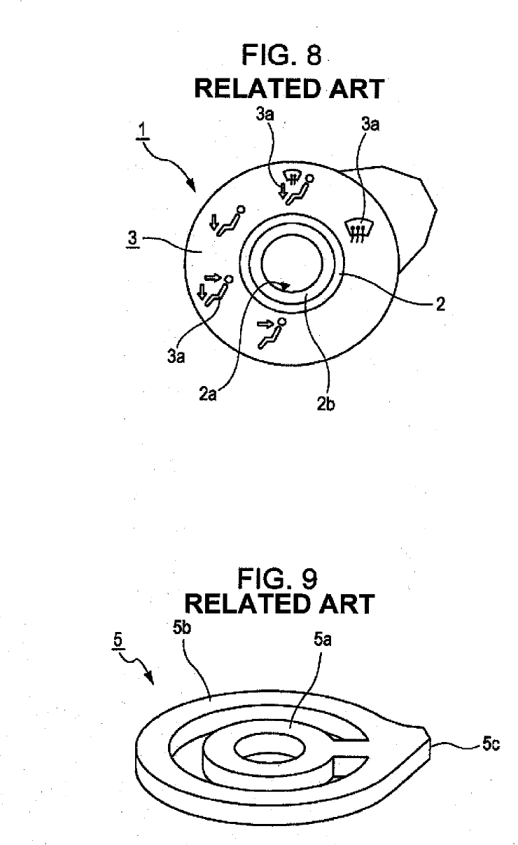

In one embodiment, of the light rays emitted from the light source 21, light rays counterclockwise entering the circular portion 22 follow the paths shown by arrows in FIG. 6. For example, as shown in FIG. 6, light rays incident on the outer collective lens 27 from the light source 21 are refracted by the lens 27 so as to head to the first reflecting surface 29a, and are then reflected by the first reflecting surface 29a so as to head into the circular portion 22.

In one embodiment, light rays incident on the inner collective lens 28 from the light source 21 are refracted by the lens 28 so as to head to the circular portion 22, and some of them are then reflected by the second reflecting surface 29b so as to head into the circular portion 22. For example, light rays incident on the inner wall surface of the light entrance portion 23 (the outer collective lens 27 and the inner collective lens 28) do not pass through the outer wall surface of the light entrance portion 23.

In one embodiment, the light leakage from the outer wall surface of the light entrance portion 23 is prevented by the reflecting portions 29 (the first and second reflecting surfaces 29a and 29b). Light rays emitted from the light source 21 forward (toward the center of the circular portion 22) are reflected by the slant surface 30b of the groove 30 so as to head into the circular portion 22. Light rays emitted from the light source 21 backward are reflected by the ridges 26a formed on the outer wall surface of the retroreflecting portion 26 so as to head to the circular portion 22. These retroreflected light rays are also incident on the outer collective lens 27 or the inner collective lens 28 and follow paths similar to those described above.

In one embodiment, the light rays emitted from the light source 21 are guided into the circular portion 22 curve counterclockwise, being repeatedly reflected by the inner wall surfaces of the circular portion 22. Some of them are reflected by the serrated reflecting surface 22b so as to emit from the emitting surface 22a. Since the circular portion 22 becomes thinner away from the light entrance portion 23, the luminance of illuminating light emitted from the emitting surface 22a of the circular portion 22 can be substantially uniform throughout the circumference.

In one embodiment, some of the light rays emitted forward from the light source 21 are reflected by the slant surface 30c so as to emit from the part of the emitting surface 22a just above the groove 30 or are reflected by the slant surfaces 22c so as to emit from the part of the emitting surface 22a near to the groove 30. Therefore, despite the groove 30, the luminance of the emitting surface 22a does not fall locally at the groove 30. The emitting surface 22a can have a uniform luminance throughout the circumference. Although not shown, light rays clockwise entering the curved light path of the circular portion 22 follow similar paths.

In one embodiment, when the surface emitting device configured as above is fitted, the circular portion 22 of the light guide 20 is disposed behind a plate (not shown) of a rotary operating electric component, and the light source 21 on the circuit board 25 is disposed in the hollow 24. Therefore, display portions (areas to be illuminated) of the plate can be illuminated with illuminating light emitted from the emitting surface 22a of the circular portion 22. The plate is disposed around a rotary knob (not shown).

In one embodiment, the plate has display portions arranged along the circumferential direction. The rotary knob has a position mark. The rotational operational position of the rotary knob can be viewed by viewing the position of the position mark relative to the display portions. The rotary knob is attached to a rotating shaft (not shown), which is rotatably supported in the circular portion 22 of the light guide 20. By rotationally operating the rotation shaft via the rotary knob, a rotary encoder (not shown) on the circuit board 25 is rotationally driven.

As described above, in the surface emitting device according to one embodiment, the light entrance portion 23 protruding from the outer peripheral surface of the circular portion 22 of the light guide 20 has the hollow 24 formed therein. The light source (lamp) 21 is disposed in the hollow 24. The light entrance portion 23 has the reflecting portions 29 formed on the outer wall surface thereof. The reflecting portions 29 bulge outward. For example, each reflecting portion 29 includes the first and second reflecting surfaces 29a and 29b.

In one embodiment, light heading from the light source 21 to the outer wall surface of the light entrance portion 23 is reflected by the reflecting portions 29 so as to head into the circular portion 22. Therefore, the amount by which the light entrance portion 23 protrudes from the circular portion 22 can be reduced, and the size of the light guide 20 in the radial direction can be reduced.

Light incident on the inner wall surface of the light entrance portion 23 and heading to the outer wall surface is reflected by the reflecting portions 29 so as to head into the circular portion 22. Therefore, light leakage from the outer wall surface of the light entrance portion 23 can be prevented, and the utilization efficiency of the light source 21 can be improved.

The inner wall surface of the light entrance portion 23 defining the hollow 24 has two pairs of the outer collective lens 27 and the inner collective lens 28, both having a convex shape. Light emitted from the light source 21 is refracted by the outer collective lenses 27 so as to head to the first reflecting surface 29a. Light rays emitted from the light source 21 are refracted by the inner collective lenses 28 so as to head to the second reflecting surface 29b. Therefore, a large part of the light incident on the inner wall surface of the light entrance portion 23 from the light source 21 can be utilized as illuminating light. Also in this respect, the utilization efficiency of the light source 21 can be improved.

In this embodiment, the outer wall surface of the light entrance portion 23 has reflecting portions 29. Each reflecting portions 29 includes the first and second reflecting surfaces 29a and 29b that are flat and that adjoin at an obtuse angle. However, the reflecting portion may include three or more flat reflecting surfaces that adjoin at an obtuse angle. Alternatively, the reflecting portion may have an approximate curved surface including a large number of adjoining reflecting surfaces.

In this embodiment, of the inner wall surface of the light entrance portion 23 defining the hollow 24, the area on the opposite side from the circular portion 22 has the retroreflecting portion 26. The light rays emitted backward from the light source 21 are reflected by the retroreflecting portion 26 so as to head to the circular portion 22. The retroreflecting portion 26 may be omitted so that the hollow 24 is a cutout. In this case, although the light rays emitted backward from the light source 21 are wasted, since the retroreflecting portion 26 is not provided, the size of the entire light guide 20 in the radial direction can be further reduced.

In this embodiment, the circular portion 22 has a V-shaped groove 30 formed in the inner peripheral surface thereof and extending in the thickness direction thereof. The light source 21 is disposed on an extension of the line P connecting the apex of the V shape (the valley 30a) of the groove 30 and the center of the circular portion 22. Therefore, light emitted from the light source 21 and heading to the center of the circular portion 22 is reflected by the slant surfaces 30b of the groove 30 so as to head into the circular portion 22. Leakage light passing through the inner peripheral surface of the circular portion 22 and heading to the center of the circular portion 22 is eliminated, and thereby the utilization efficiency of the light source 21 can be improved.

In one embodiment, the end of the groove 30 on the emitting surface 22a side is closed, and the closed end has a slant surface 30c that slants toward the emitting surface 22a. Therefore, part of the light heading from the light source 21 to the center of the circular portion 22 is reflected by the slant surface 30c that is formed at the upper end of the groove 30, and is guided to the emitting surface 22a. Therefore, despite the groove 30, the luminance of the emitting surface 22a is prevented from falling locally at the groove 30. The entire emitting surface 22a including the place where the groove 30 is formed can have a uniform luminance throughout the circumference.

In one embodiment, the serrated reflecting surface 22b side of the circular portion 22 has a pair of slant surfaces 22c facing each other across the groove 30. The slant surfaces 22c also slant toward the emitting surface 22a. Therefore, part of the light heading from the light source 21 to the center of the circular portion 22 is reflected by the slant surfaces 22c and guided to the part of the emitting surface 22a on either side of the groove 30. Therefore, the illumination by the slant surfaces 22c, coupled with the illumination by the slant surface 30c, effectively prevents the luminance of the emitting surface 22a from falling locally at the area corresponding to the groove 30. The emitting surface 22a can have a uniform luminance throughout the circumference.

In one embodiment, the light entrance portion 23, which protrudes from the outer peripheral surface of the circular portion 22, has the hollow 24 formed in the center thereof. The light source 21 is disposed in the hollow 24 and emits light toward the inner wall surface of the light entrance portion 23. Therefore, the amount by which the light entrance portion 23 protrudes from the circular portion 22 can be reduced, and the size of the light guide 20 in the radial direction can be reduced.

In one embodiment, a large part of the light incident on the inner wall surface of the light entrance portion 23 from the light source 21 can be utilized as illuminating light. Also in this respect, the utilization efficiency of the light source 21 can be improved.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

What is claimed is:

1. A surface emitting device comprising:
a light guide comprising a circular portion and a light entrance portion that protrudes from an outer peripheral surface of the circular portion; and
a light source that is operative to emit light toward the light entrance portion, the light source being disposed in a hollow formed substantially in the center of the light entrance portion,
wherein the outer wall surface of the light entrance portion has a reflecting portion that bulges outward, and the reflecting portion is operative to reflect the light that heads from the light source to the outer wall surface of the light entrance portion into the circular portion.

2. The surface emitting device according to claim 1, wherein the reflecting portion comprises a first reflecting surface and a second reflecting surface, the first reflecting surface and the second reflecting surface adjoin at an obtuse angle.

3. The surface emitting device according to claim 2, wherein the inner wall surface of the light entrance portion that defines the hollow has an outer collective lens that is convex and formed between the light source and the first reflecting surface, and the outer collective lens is operative to refract light from the light source to the first reflecting surface.

4. The surface emitting device according to claim 3, wherein the inner wall surface of the light entrance portion has an inner collective lens that is convex and adjoins the outer collective lens, and inner collective lens is operative to refract light from the light source into the circular portion.

5. A surface emitting device comprising:
a light guide comprising a circular portion and a light entrance portion protruding from an outer peripheral surface of the circular portion; and
a light source emitting light toward the light entrance portion,
the circular portion comprising an emitting surface and a reflecting surface that face each other,
wherein the inner peripheral surface of the circular portion has a groove with edges that face each other in the circumferential direction.

6. The surface emitting device according to claim 5, wherein the light source is disposed on an extension of a line connecting the apex of the groove and the center of the circular portion.

7. The surface emitting device according to claim 5, wherein the end of the groove on the emitting surface side is closed, and the closed end has a slant surface that slants toward the emitting surface.

8. The surface emitting device according to claim 5, wherein the light entrance portion has a hollow formed substantially in the center thereof, and the light source is disposed in the hollow.

8. The surface emitting device according to claim 5, wherein the cross section of the groove converges outward so as to have a V shape.

9. A method of emitting light from a surface emitting device, the method comprising:
providing a light guide comprising a circular portion and a light entrance portion that protrudes from an outer peripheral surface of the circular portion;
emitting light toward the light entrance portion;
reflecting the emitted light into the circular portion.
